(19) United States
(12) Patent Application Publication
(10) Pub. No.: US 2010/0080645 A1
(43) Pub. Date: Apr. 1, 2010

(54) Whiteboard marker

(76) Inventor: Jiayi Wu, Dongguan City (CN)

Correspondence Address: CHARLES E. BAXLEY, ESQUIRE, 90 JOHN STREET, SUITE 309, NEW YORK, NY, 10038, US

(21) Appl. No.: 12/380,413

(22) Filed: Feb. 26, 2009

(30) Foreign Application Priority Data
Sep. 27, 2008 (CN) 200820201268.1

(51) Int. Cl. B43K 29/00

(52) U.S. Cl. 401/52

(57) ABSTRACT

A whiteboard marker, comprises a lid; a body provided with an ink reservoir cotton inside and an ink introducing core at the penpoint portion; wherein the lid is hollow, a seal cap for sealing the body is provided at an end of the body adjacent to the lid, and one end of the seal cap away from the body extends into the lid to be connected with the lower end of a rotation element by screwing, an eraser retainer is provided at the upper end of the rotation element, an eraser is provided at the front end of the eraser retainer, and the penpoint portion is inserted into the other end of the seal cap. The whiteboard marker may be used for writing and erasing easily, and can be recycled to save resource and be environment-protected.

### TECHNICAL FIELD

The present invention relates to a marker, in particular to a whiteboard marker.

### BACKGROUND OF THE INVENTION

Whiteboard marker is widely used in various fields such as speech, demonstration, and teaching, and gradually replaces the chalk. The whiteboard marker may be used for writing and erasing easily, and can be recycled to save resource and be environment-protected. Various whiteboard markers have been available, and most of them have a same problem that is an additional eraser should be used for erasing when the whiteboard marker is used, which is inconvenient and waste of time. Moreover, the additional eraser may be used insufficiently such that it is waste of resource. Accordingly, it is desirable to develop a whiteboard marker with better performances.

### SUMMARY OF THE INVENTION

Having outlined the state of the prior art and its attendant shortages, it is an object of the present invention to provide a whiteboard marker capable to be used for writing and erasing and be recycled.

The above object of the present invention is achieved by the following technical solutions:

A whiteboard marker comprises a lid; a body being provided with an ink reservoir cotton inside and an ink introducing core at the penpoint portion; wherein the lid is hollow, a seal cap for sealing the body is provided at an end of the body adjacent to the lid, and one end of the seal cap away from the body extends into the lid to be connected with the lower end of a rotation element by screwing, an eraser retainer is provided at the upper end of the rotation element an eraser is provided at the front end of the eraser retainer, and the penpoint portion is inserted into the other end of the seal cap.

Preferably, the seal cap is provided with a ring rib at the joint between the seal cap and the penpoint of the body for engaging with a corresponding locking portion on the body, the seal cap is also provided with a ring groove for engaging with a ring rib on the lid, the end of the seal cap extending into the lid is designed into a thread end for engaging with the lower end of the rotation element.

Preferably, the rotation element is hollow and provided with internal thread in the lower end, the thread end of the seal cap extending into the rotation element is engaged with the internal thread of the lower end of the rotation element, the upper end of the rotation element is provided with a positioning groove for engaging with a positioning protrusion on the lower end of the eraser retainer, the eraser is provided at the upper end of the eraser retainer.

Preferably, the lower end of the lid is circular, while the upper end of the lid is brush-shaped with an end opening for matching a rectangle eraser, and a magnet is provided on the outer surface of the lower end of the lid.

Preferably, the body is opened at the rear end, the opened rear end has an internal thread for engaging with the corresponding thread on one end of a tail plug, the outer end of the tail plug is provided with a groove.

Preferably, the end of the tail plug inserted into the body is hollow, a seal piece having one end inserted into the tail plug is of a cross rib at the other end.

Preferably, one end of a pen retainer is inserted into the penpoint end of the body, the other end of the pen retainer is protruded radially to be blocked by the penpoint, and one end of the ink introducing core is inserted into the pen retainer to connect with the ink reservoir cotton, while the other end of the ink introducing coreis protruded radially to be blocked by the pen retainer.

The advantages of the present invention are as follow:

1. the lid is hollow and provided with the eraser, and the eraser can be extended from or withdrawn into the opening of the lid by rotating the body, thus the using of eraser is convenient and clean for the environment;

2. the seal cap can be inserted into the body to prevent the ink from volatilization from the penpoint;

3. a magnet provided on the outer surface of the lower end of the lid allows the whiteboard marker to be attached onto a whiteboard;

4. the body is provided a tail plug, and when the ink is used up, the rail plug may be opened to add the ink, which saves materials and is good for environmental protection;

5. a seal piece which has a cross rib at the end contacting with the ink reservoir cotton, presses onto the ink reservoir cotton, which reduces the volatilization of ink in the ink reservoir cotton.

### BRIEF DESCRIPTION OF THE DRAWINGS

FIG. 1 is a front view of a whiteboard marker according to an embodiment of the present invention;

FIG. 2 is a side view of a whiteboard marker according to an embodiment of the present invention;

FIG. 3 is a perspective view of a whiteboard marker according to an embodiment of the present invention;

FIG. 4 is a schematic view showing the position relationship between the lid and the eraser;

FIG. 5 is a schematic view showing the tail plug;

FIG. 6 is an exploded view of a whiteboard marker according to an embodiment of the present invention;

FIG. 7 is a sectional view of a whiteboard marker, taking along the A-A line in FIG. 1.

### DETAILED DESCRIPTION OF THE INVENTION

The invention will now be described with reference to the accompanying drawings, which illustrate by way of example and not by way of limitation, preferred embodiments of this invention.

The main parts of the whiteboard marker are as follow: a lid 4, a body 9, an ink reservoir cotton 10, an ink introducing core 7, a seal cap 6, a rotation element 3, an eraser retainer 2, and an eraser 1.

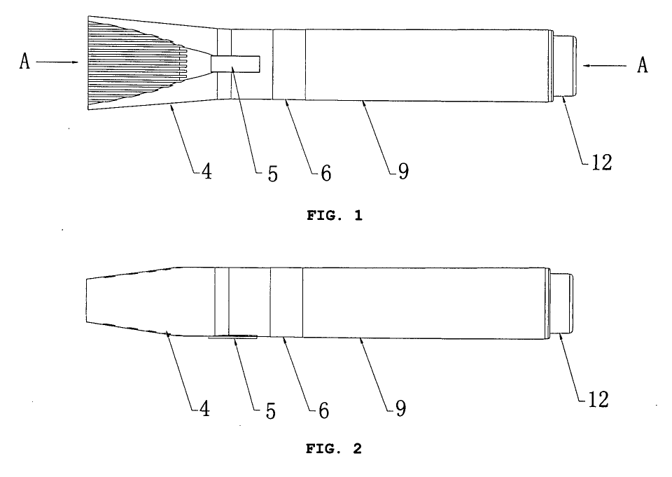

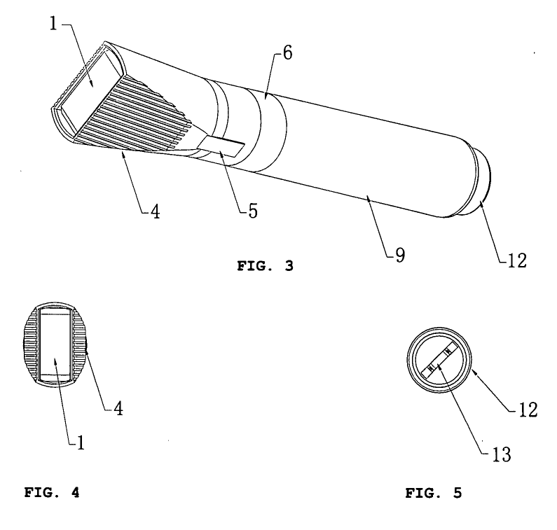

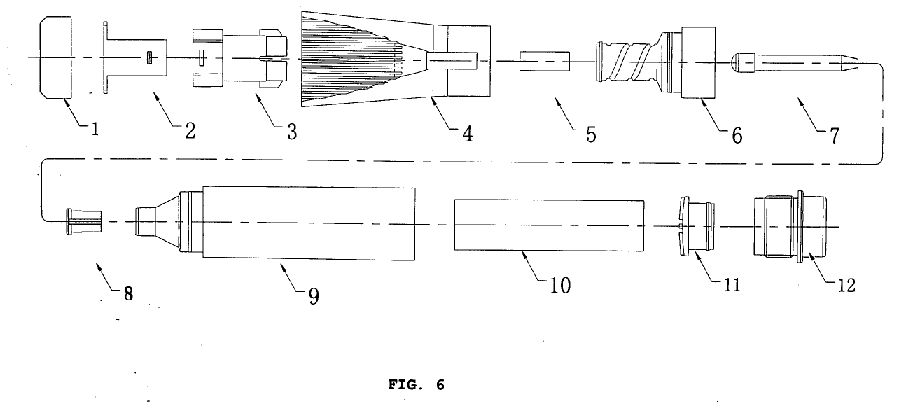

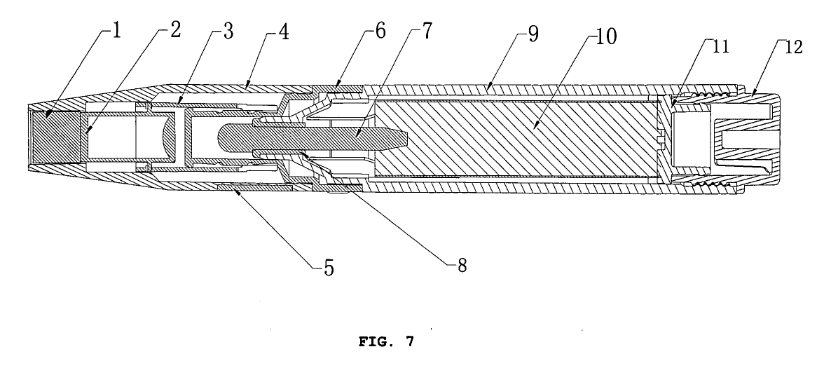

Referring to FIG. 1 to FIG. 7, a whiteboard marker comprises a lid 4; a body 9 being provided with an ink reservoir cotton 10 inside and an ink introducing core 7 at the penpoint portion; wherein the lid 4 is hollow, a seal cap 6 for sealing the body 9 is provided at an end of the body 9 adjacent to the lid 4, and one end of the seal cap 6 away from the body 9 extends into the lid 4 to be connected with the lower end of a rotation element 3 by screwing, an eraser retainer 2 is provided at the upper end of the rotation element 3, an eraser 1 is provided at the front end of the eraser retainer 2, and the penpoint portion is inserted into the other end of the seal cap 6.

Preferably, the seal cap 6 is provided with a ring rib at the joint between the seal cap 6 and the penpoint of the body 9 for engaging with a corresponding locking portion on the body 9; when the body 9 is rotated, the seal cap 6 is thus rotated together; ink volatilization can be prevented by the good sealing performance between the seal cap 6 and the body 9. The seal cap 6 is also provided with a ring groove for engaging with a ring rib on the lid 4. The seal cap 6 can be rotated 360 degree. The end of the seal cap 6 extending into the lid 4 is designed into a thread end for engaging with the lower end of the rotation element 3.

Preferably, the rotation element 3 is hollow and provided with internal thread in the lower end, the thread end of the seal cap 6 extending into the rotation element 3 is engaged with the internal thread of the lower end of the rotation element 3. When the seal cap 6 is rotated clockwise, the rotation element 3 is thus moved upwards. In contrary, when the seal cap 6 is rotated counter-clockwise, the rotation element 3 is moved downwards. The upper end of the rotation element 3 is provided with a positioning groove for engaging with a positioning protrusion on the lower end of the eraser retainer 2, the eraser 1 is provided at the upper end of the eraser retainer 2. The eraser retainer 2, the eraser 1 and the rotation element 3 are moved in the same direction.

Preferably, the lower end of the lid 4 is circular, while the upper end of the lid 4 is brush-shaped, so that the rotation element 3 can only be moved up and down along the lid 4, and in this way, the rotation element 3 is moved up and down when the seal cap 6 is rotated. The lid 4 has an end opening of the lid 4 for matching with a rectangle eraser, and a magnet 5 on the outer surface of the lower end of the lid 4. When

Preferably, the body 9 is opened at the rear end, the opened rear end has an internal thread for engaging with the corresponding thread on one end of a tail plug 12, the outer end of the tail plug 12 is provided with a groove 13. When the ink is used up, the tail plug 12 can be rotated by rotating an element such as a key or a coin which is inserted into the groove 13, and then ink may be added into the ink reservoir cotton 10, after which the tail plug 12 is covered.

Preferably, the end of the tail plug 12 inserted into the body 9 is hollow, a seal piece 11 having one end inserted into the tail plug 12 is of a cross rib at the other end. The seal piece 11 can press and seal the ink reservoir cotton 10 well to reduce the volatilization of ink.

Preferably, one end of a pen retainer 8 is inserted into the penpoint end of the body 9, the other end of the pen retainer 8 is protruded radially to be blocked by the penpoint, and one end of the ink introducing core 7 is inserted into the pen retainer 8 to connect with the ink reservoir cotton 10, while the other end of the ink introducing core 7 is protruded radially to be blocked by the pen retainer 8.

With the present invention, the user only have to rotate the rotation element 3 clockwise to expose the eraser 1 from the opening of the lid 4 for erasing, and to rotate the rotation element 3 counter-clockwise to withdraw the eraser 1 into the opening when it is not in use, which is convenient for use and clean for the environment. For the arrangement of the tail plug 12 that is capable to be opened by turning and a magnet 5 that is provided on the outer surface of the lower end of the lid 4, the present invention is of better using property, environmental-protection performance.

1. A whiteboard marker, comprising:
a lid (4);
a body (9) provided with an ink reservoir cotton (10) inside and an ink introducing core (7) at the penpoint portion;
wherein the lid (4) is hollow, a seal cap (6) for sealing the body (9) is provided at an end of the body (9) adjacent to the lid (4), and one end of the seal cap (6) away from the body (9) extends into the lid (4) to be connected with the lower end of a rotation element (3) by screwing, an eraser retainer (2) is provided at the upper end of the rotation element (3), an eraser (1) is provided at the front end of the eraser retainer (2), and the penpoint portion is inserted into the other end of the seal cap (6).

2. The whiteboard marker of claim 1, wherein the seal cap (6) is provided with a ring rib at the joint between the seal cap (6) and the penpoint of the body (9) for engaging with a corresponding locking portion on the body (9), the seal cap (6) is also provided with a ring groove for engaging with a ring rib on the lid (4), the end of the seal cap (6) extending into the lid (4) is designed into a thread end for engaging with the lower end of the rotation element (3).

3. The whiteboard marker of claim 1 or 2, wherein the rotation element (3) is hollow and provided with internal thread in the lower end, the thread end of the seal cap (6) extending into the rotation element (3) is engaged with the internal thread of the lower end of the rotation element (3), the upper end of the rotation element (3) is provided with a positioning groove for engaging with a positioning protrusion on the lower end of the eraser retainer (2), the eraser (1) is provided at the upper end of the eraser retainer (2).

4. The whiteboard marker of claim 1, wherein the lower end of the lid (4) is circular, while the upper end of the lid (4) is brush-shaped with an end opening for matching a rectangle eraser, and a magnet (5) is provided on the outer surface of the lower end of the lid (4).

5. The whiteboard marker of claim 1, wherein the body (9) is opened at the rear end, the opened rear end has an internal thread for engaging with the corresponding thread on one end of a tail plug (12), the outer end of the tail plug (12) is provided with a groove (13).

6. The whiteboard marker of claim 5, wherein the end of the tail plug (12) inserted into the body (9) is hollow, a seal piece (11) having one end inserted into the tail plug (12) is of a cross rib at the other end.

7. The whiteboard marker of claim 1, wherein one end of a pen retainer (8) is inserted into the penpoint end of the body (9), the other end of the pen retainer (8) is protruded radially to be blocked by the penpoint, and one end of the ink introducing core (7) is inserted into the pen retainer (8) to connect with the ink reservoir cotton (10), while the other end of the ink introducing core (7) is protruded radially to be blocked by the pen retainer (8).
